(19) United States
(12) Patent Application Publication
(10) Pub. No.: US 2010/0260966 A1
(43) Pub. Date: Oct. 14, 2010

(54) Dimensionally-Stabilized Cushioned Carpet Tile and Methods of Manufacture Thereof

(75) Inventor: Shawn David McGill, Dalton, GA (US)

Correspondence Address: SUTHERLAND ASBILL & BRENNAN LLP, 999 PEACHTREE STREET, N.E., ATLANTA, GA, 30309, US

(73) Assignee: BEAULIEU GROUP, LLC, Dalton, GA (US)

(21) Appl. No.: 12/757,331

(22) Filed: Apr. 9, 2010

Related U.S. Application Data
(60) Provisional application No. 61/167,952, filed on Apr. 9, 2009.

(51) Int. Cl. B32B 5/02; B32B 37/00

(52) U.S. Cl. 428/95; 156/60

(57) ABSTRACT

A carpet tile is provided that includes a face fabric having a top surface and a base, and a dimensionally-stabilized non-woven cushion material having a stabilizing material incorporated therein, incorporated thereonto or a combination thereof. The dimensionally-stabilized non-woven cushion material may be attached to the face fabric such that the dimensionally-stabilized non-woven cushion material provides dimensional stability to the face fabric. Methods of manufacturing dimensionally-stabilized cushioned carpet tile are also provided.

### CROSS REFERENCE TO RELATED APPLICATIONS

This application claims priority under 35 U.S.C. §119(e) to U.S. Provisional Patent Application Ser. No. 61/167,952, filed on Apr. 9, 2009, which is incorporated herein by reference in its entirety.

### STATEMENT REGARDING FEDERALLY SPONSORED RESEARCH OR DEVELOPMENT

Not applicable.

### BACKGROUND OF THE INVENTION

This invention relates generally to the field of carpets and carpet tiles, and more particularly to carpet tiles having integrated cushioning.

Carpet tiles are modular floor coverings having a textile top surface which are arranged and installed on various types of floor surfaces. Carpet tile production involves the lamination of a face fabric with a carpet tile backing polymer. Conventionally, the backing polymer comprises PVC, polyethylene, modified polypropylenes, ethyl vinyl acetate, modified PET or blends thereof.

Dimensional stability is critical in carpet tile applications to prevent growth or shrinkage of the carpet tile when it is exposed to variations in temperature and humidity. Dimensional stability is achieved by the addition of stabilizing materials, such as fiberglass scrims, non-woven PET, polyamides, and polypropylene, to the backing polymer. The stabilizing material is customarily combined with the backing polymer by a lamination process such as extrusion, hot melt, and belt lamination.

Some carpet tiles are cushioned. These “cushioned” or “cushion-backed” carpet tiles include a cushion material that is bonded to the stabilized carpet tile product. Various materials are used for cushioning, including, for example, non-woven fiber pads and foam materials. As with non-cushioned carpet tiles, dimensional stability is provided by stabilizing materials in the backing polymer of the cushion-backed carpet tiles.

### BRIEF SUMMARY OF THE INVENTION

In one aspect, a carpet tile is provided. The carpet tile may comprise a face fabric having a top surface and a base; and a dimensionally-stabilized non-woven cushion material having a stabilizing material incorporated therein, incorporated thereonto or a combination thereof. The dimensionally-stabilized non-woven cushion material may be attached to the face fabric such that the dimensionally-stabilized non-woven cushion material provides dimensional stability to the face fabric.

In another aspect, a carpet tile is provided that comprises a primary carpet base having a face fabric side and an opposed back side; a polymer adhesive layer attached to the back side of the primary carpet base; and a dimensionally stabilized non-woven cushion material layer attached to the primary carpet base by the polymer adhesive layer, the dimensionally stabilized non-woven cushion material having a stabilizing material incorporated therein, incorporated thereonto or a combination thereof.

In yet another aspect, a method of manufacturing a carpet tile is provided. The method may comprise integrating a stabilizing material with a cushion material to form a dimensionally-stabilized cushion material; and attaching the dimensionally-stabilized cushion material to a face fabric.

In yet another aspect, a method of manufacturing a carpet tile that comprises producing a face fabric comprising a plurality of pile extending from a primary carpet base; producing a dimensionally-stabilized cushion pad comprising a non-woven cushion material and a stabilizing material incorporated therewith; laminating the dimensionally-stabilized cushion pad to the face fabric with a polymer adhesive; and curing the polymer adhesive such that it locks the plurality of pile to the primary carpet base and bonds the dimensionally-stabilized cushion pad to the face fabric.

### BRIEF DESCRIPTION OF THE DRAWINGS

FIG. 1 is a section view, illustrating a dimensionally-stabilized cushioned carpet tile in accordance with one or more embodiments of the present invention.

FIG. 2 is a schematic, illustrating a method of manufacturing a dimensionally-stabilized cushioned carpet tile in accordance with one or more embodiments of the present invention.

### DETAILED DESCRIPTION OF THE INVENTION

An improved cushioned carpet tile has been developed, along with a new method of manufacturing the carpet tile. The cushioned carpet tile includes stabilizing material integrated directly with the cushion material. Because the cushion of the carpet tile is stabilized, stabilizing material need not be added to the backing polymer. In a preferred embodiment, stabilizing material is not provided in the backing polymer of the fabric face apart from the dimensionally-stabilized non-woven fiber pad.

The term “stabilizing material” as used herein is intended to encompass essentially any suitable material known in the art for imparting dimensional stability to a carpet tile and/or for reducing growth/shrinkage/curling of the carpet tile when the carpet tile is exposed to reasonably expected variations in temperature and humidity. Representative examples of materials that may be employed as the stabilizing material for the carpet tile described herein include, but are not limited to, woven and non-woven fiberglass scrims and scrims of other natural or synthetic fibers; non-woven fabrics, such as non-woven polyethylene teraphthalate (PET), polyamides, polypropylene, polyester, or blends thereof; and combinations thereof.

### Carpet Tiles Having Dimensionally-Stabilized Cushioning

In one aspect, a carpet tile having a dimensionally-stabilized cushion is provided. In some embodiments, the carpet tile comprises a face fabric having a top surface and a base; and a dimensionally-stabilized non-woven cushion material having a stabilizing material incorporated therein, incorporated thereonto or a combination thereof. The dimensionally-stabilized non-woven cushion material may be attached to the face fabric such that the dimensionally-stabilized non-woven cushion material provides dimensional stability to the face fabric.

In some embodiments, the carpet tile may comprise a primary carpet base having a face fabric side and an opposed back side; a polymer adhesive layer attached to the back side of the primary carpet base; and a dimensionally stabilized non-woven cushion material layer attached to the primary carpet base by the polymer adhesive layer. The dimensionally stabilized non-woven cushion material may have a stabilizing material incorporated therein, incorporated thereonto or a combination thereof.

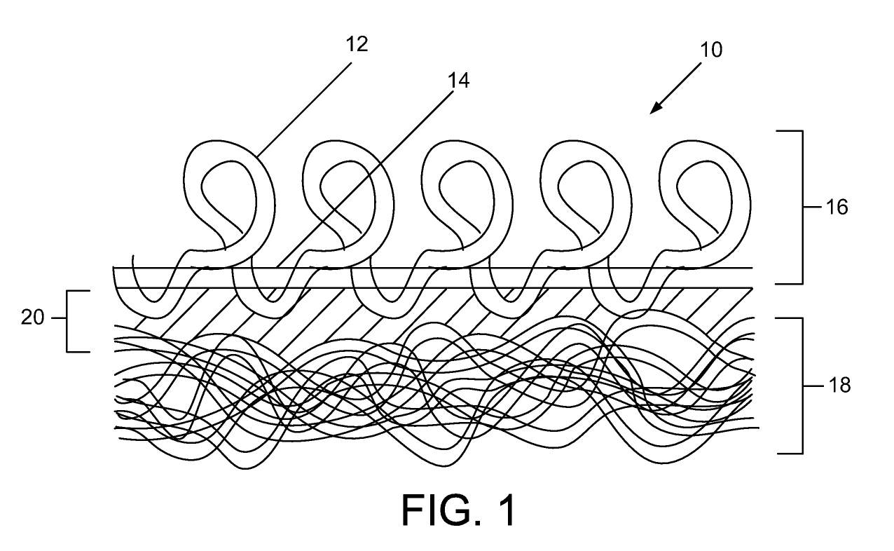

FIG. 1 is a cross-section view, illustrating an embodiment of a carpet tile having a dimensionally-stabilized cushion. The cushioned carpet tile 10 includes a face fabric 16 having a plurality of tufts 12 created by sewing a yarn through the primary carpet base 14. Although a “loop pile” type face fabric 16 is illustrated, the face fabric of the carpet tiles can be of any type, including cut pile, loop pile, cut and loop pile, tufted, bonded, woven, non-woven, or the like.

The face fabric 16 is attached to a cushion material 18 by a polymer adhesive 20. The polymer adhesive 20 may be any adhesive suitable for locking the tufts 12 to the primary carpet base 14. In a preferred embodiment, the polymer adhesive 20 is also suitable for bonding the cushion material 18 to the face fabric 16. Representative examples of polymer adhesives suitable for such purposes include, but are not limited to PVC, polyethylenes, modified polyproplyenes, ethyl vinyl acetates, modified PET's and blends thereof.

The cushion material 18 comprises a dimensionally-stabilized, i.e., pre-stabilized, non-woven fiber pad. The non-woven fiber pad may be of various non-woven constructions including, but not limited to needle-punched, spunbound, or fusion bonded. The pre-stabilized non-woven fiber pad 18 includes a non-woven stabilizing material integrated with the non-woven fiber pad. For example, the stabilizing material may be incorporated into the non-woven fiber pad, incorporated onto the non-woven fiber pad, or both. In certain embodiments, the non-woven stabilizing material may comprise PET, polyamides, polypropylene or blends thereof. The stabilizing material may be arranged in regular or irregular patterns throughout the non-woven fiber pad. In this way, the cushion material 18 provides both cushioning for the carpet tile and dimensional stability to restrict shrinkage, growth and/or curling. Furthermore, the pre-stabilized cushion material 18 imparts sufficient dimensional stability to cushioned carpet tile 10 such that additional stabilizing material is not required.

The stabilizing material may incorporated into or onto the cushion material in various forms depending on the nature of the cushion material. For needle-punched cushion material, the stabilizing material may be intermixed with the fibers of the cushion material in the direction of the plane of the cushion pad and in a direction perpendicular to the plane of the cushion pad. Moreover, for spunbound and fusion-bonded cushion pads the stabilizing material may be thermally or adhesively bonded within or onto the cushion pad.

The carpet tiles may be of any desired geometry and area dimension. A preferred shape is that of a square tile. Particularly preferred are square tiles which are 18 inches by 18 inches (45.72 cm by 45.72 cm), 36 inches by 36 inches (91.44 cm by 91.44 cm), 50 cm by 50 cm, or 1 m by 1 m. Tiles having different dimensions and shapes are also contemplated. The carpet tiles also may be of any desired thickness. For example, the carpet tiles may have an overall thickness from about 0.15 inches to about 0.75 inches (3.81 mm to about 19.05 mm).

Methods of Manufacturing Carpet Tiles with Dimensionally-Stabilized Cushioning

In another aspect, methods of manufacturing a cushioned carpet tile having a pre-stabilized cushion material are provided. In a preferred embodiment, the method comprises integrating a stabilizing material with a cushion material to form a dimensionally-stabilized cushion material; and attaching the dimensionally-stabilized cushion material to a face fabric.

In a preferred embodiment, the method of manufacturing the carpet tile may comprise producing a face fabric comprising a plurality of pile extending from a primary carpet base; producing a dimensionally-stabilized cushion pad comprising a non-woven cushion material and a stabilizing material incorporated therewith; laminating the dimensionally-stabilized cushion pad to the face fabric with a polymer adhesive; and curing the polymer adhesive such that it locks the plurality of pile to the primary carpet base and bonds the dimensionally-stabilized cushion pad to the face fabric.

In a preferred embodiment, the non-woven stabilizing material is integrated directly with the non-woven fiber pad prior to laminating the cushion material to the fabric face on the carpet tile production line. The lamination of the pre-stabilized pad can be accomplished with carpet tile backing polymers (e.g., PVC, polyethylenes, modified polyproplyenes, ethyl vinyl acetates, modified PET's or blends thereof) using a number of processes including, but not limited to extrusion, hot melt and belt lamination. The non-woven fiber pad may be directly applied to the carpet tile substrate in one production step. This allows the polymer adhesive to both lock the pile of the face fabric to the primary carpet base and bond the dimensionally-stabilized cushion pad to the face fabric. As such, the pre-stabilized carpet tile fiber pad imparts sufficient dimensional stability to the carpet tile so that no additional stabilizing material is needed during the carpet tile production process.

In certain embodiments, the cushioned carpet tiles are first produced as a larger broadloom floor covering by a broadloom manufacturing process. Generally, this involves a first process in which the face fabric 16 is produced by tufting or fusion bonding; a second process in which the cushion material 18 is produced, and the stabilizing material is incorporated therewith; a third lamination process in which the face fabric 16 is laminated to the cushion material 18 with the polymer adhesive 20; and a curing process in which the broadloom is fed through an oven or other device to dry and/or cure the polymer adhesive 20. The broadloom is then cooled and cut into individual carpet tiles.

The stabilizing material may be integrated with the cushion material 18 at any stage prior to laminating the cushion material 18 to the face fabric 16. For example, fibers of stabilizing material may be fed with other fibers to a carding machine and embedded in the non-woven fabric before the non-woven fabric is fed to a needle-punch apparatus. Alternatively, the stabilizing material may be incorporated with the non-woven fabric during needle-punch operations or after the non-woven fabric has been needle-punched.

For spunbound cushion materials, the stabilizing material may be extruded and/or spun with the filaments of the cushion material or may be otherwise incorporated into the spunbound non-woven web during laydown or bonding operations. Alternatively, the stabilizing material may be added to the non-woven spunbound cushion material at a later stage. For fusion-bonded cushion materials, the stabilizing material may be mixed with the filaments of the cushion material before or during adhesive application or heat-fusion operations. Alternatively, the stabilizing material may be added to the non-woven fusion-bonded cushion material at a later stage.

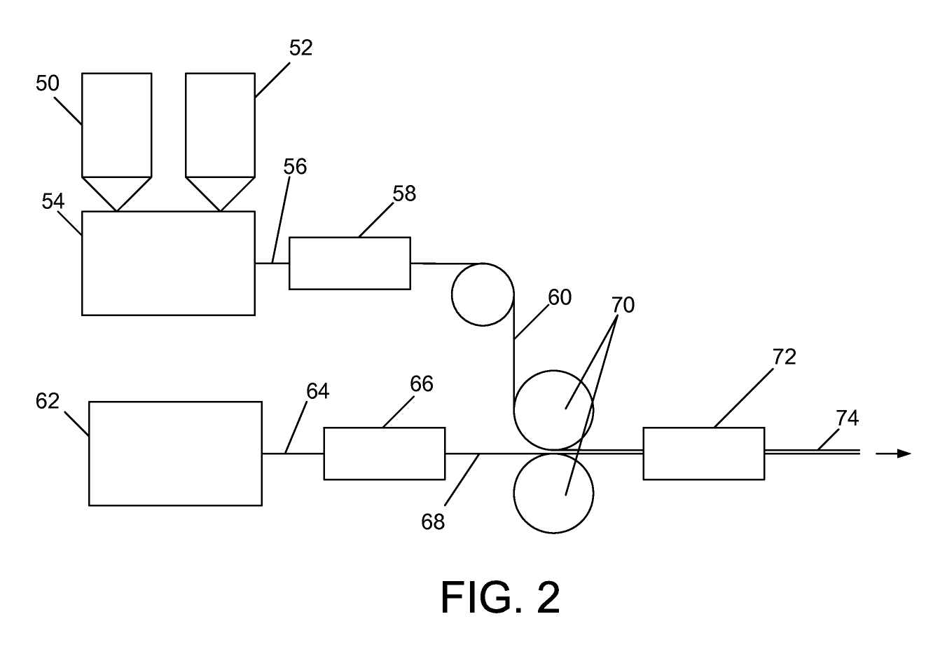

FIG. 2 is a schematic illustrating a method of manufacturing a dimensionally-stabilized cushion carpet tile. Two hoppers 50 and 52 supply a cushion material and a stabilizing material to a non-woven pad forming apparatus 54, respectively. The non-woven pad forming apparatus 54 may be a carding machine that receives fibers of the cushion material and the stabilizing material from the hoppers 50 and 52. In another embodiment, the apparatus 54 may be operable for producing a spunbound or fusion-bonded non-woven web comprising fibers of the cushion material and the stabilizing material. In certain embodiments, the hoppers 50 and 52 may feed pellets of the cushion material and the stabilizing material to extruders to produce fibers of the cushion and stabilizing materials. In spunbonding applications, the apparatus 54 may comprise one or more devices for spinning the fibers onto a moving conveyor and a heating device for bonding overlapping fibers together. In fusion-bonding applications, the apparatus 54 may comprise an adhesive applicator and/or heating devices for curing the adhesive and bonding fibers together. The non-woven fiber web 56 formed by the apparatus 54 may then be fed to a needle-punching apparatus 58 to produce a needle-punched non-woven fiber cushion 60.

A face fabric 64 is produced by a loom apparatus 62. The face fabric 64 is then fed to an adhesive application station 66 where an adhesive backing polymer is applied to the back of face fabric 64. The backing polymer may be applied to the face fabric 64 by various processes including extrusion, hot melt and belt lamination. The adhesive-backed face fabric 68 is then fed through laminating rollers 70 where the needle-punched non-woven fiber cushion 60 is laminated to the adhesive-backed face fabric 68. The laminated web is then fed through an oven 72 where the adhesive is cured, thereby locking together the components of the face fabric and bonding the face fabric to the non-woven fiber cushion 60. The cured laminate 74 may then be cooled and cut into individual carpet tiles.

Although the non-woven pad forming apparatus 54 and loom apparatus 62 are illustrated as operating simultaneously as part of an interconnected in-line production process, it should be noted that the non-woven pad may be formed separately from the face fabric as part of an offline process. For example, a preformed dimensionally-stabilized cushion web may be fed from a supply roll directly to the laminating rollers 70 where it is laminated to the face fabric.

In order to determine whether a pre-stabilized cushion material 18 is capable of providing sufficient stabilization without requiring addition of stabilizing materials to the polymer adhesive 20, cushioned carpet tiles produced using the foregoing method were subjected to the Aachen test. The Aachen test is a standardized test defined by the Aachen Institute in Europe for evaluating dimensional stability. The test protocol involves measuring the dimensions of a section of carpet which has been at room temperature for 24 hours. Then, the carpet is heated for 2 hours at 140° F. (60° C.), immersed in water for 2 hours at room temperature, removed from the water and heated for 24 hours at 140° F. (60° C.), then left at room temperature for 48 hours. The dimensions of the carpet are then measured again and the change is calculated.

The results of the Aachen test demonstrated that carpet tiles manufactured by the foregoing methods using pre-stabilized cushion have comparable dimensional stability to that of traditionally manufactured cushioned carpet tiles in which the stabilizing material is integrated with the backing polymer and the cushion is laminated to the backing polymer. These results are surprising since it was previously believed that stabilizing material was required to be closer to the face of the carpet (i.e., such as in the backing polymer) in order to impart the required dimensional stability to the carpet tile. Furthermore, these successful dimensional stability results have been achieved without the use of fiberglass and at a total carpet tile weight that is approximately 10% lighter than conventional urethane cushion tiles.

Modifications and variations of the methods and devices described herein will be obvious to those skilled in the art from the foregoing detailed description. Such modifications and variations are intended to come within the scope of the appended claims.

We claim:

1. A carpet tile comprising:
a face fabric having a top surface and a base; and
a dimensionally-stabilized non-woven cushion material having a stabilizing material incorporated therein, incorporated thereonto, or a combination thereof, wherein the dimensionally-stabilized non-woven cushion material is attached to the base if the face fabric such that the dimensionally-stabilized non-woven cushion material provides dimensional stability to the face fabric.

2. The carpet tile of claim 1, wherein the stabilizing material comprises non-woven PET, polyamide, polypropylene or a blend thereof.

3. The carpet tile of claim 1, wherein the cushion material comprises a needle-punched fiber pad.

4. The carpet tile of claim 1, wherein the stabilizing material is arranged in regular or irregular patterns throughout the non-woven fiber pad.

5. The carpet tile of claim 1, wherein the dimensionally-stabilized non-woven cushion provides sufficient dimensional stability to prevent shrinkage, growth, or curling of the carpet tile.

6. The carpet tile of claim 1, wherein the dimensionally-stabilized non-woven cushion provides sufficient dimensional stability to prevent shrinkage, growth, or curling of the carpet tile without requiring the use of additional stabilizing material.

7. A carpet tile comprising:
a primary carpet base having a face fabric side and an opposed back side;
a polymer adhesive layer attached to the back side of the primary carpet base; and
a dimensionally stabilized non-woven cushion material layer attached to the primary carpet base by the polymer adhesive layer, the dimensionally stabilized non-woven cushion material having a stabilizing material incorporated therein, incorporated thereonto, or a combination thereof.

8. The carpet tile of claim 7, wherein the stabilizing material comprises non-woven PET, polyamide, polypropylene or a blend thereof.

9. The carpet tile of claim 7, wherein the cushion material comprises a needle-punched fiber pad.

10. The carpet tile of claim 7, wherein the stabilizing material is arranged in regular or irregular patterns throughout the non-woven fiber pad.

11. The carpet tile of claim 7, wherein the dimensionally-stabilized non-woven cushion provides sufficient dimensional stability to prevent shrinkage, growth, or curling of the carpet tile.

12. The carpet tile of claim 7, wherein the dimensionally-stabilized non-woven cushion provides sufficient dimensional stability to prevent shrinkage, growth, or curling of the carpet tile without requiring the use of additional stabilizing material.

13. A method of manufacturing a carpet tile comprising:
integrating a stabilizing material with a cushion material to form a dimensionally-stabilized cushion material; and
attaching the dimensionally-stabilized cushion material to a face fabric.

14. The method of claim 13, wherein the cushion material is attached to the face fabric with a polymer adhesive.

15. The method of claim 13, wherein the stabilizing material is incorporated into the cushion material before the cushion material is attached to the face fabric.

16. The method of claim 13, wherein the stabilizing material comprises non-woven PET, polyamide, polypropylene, or a blend thereof.

17. The method of claim 13, wherein the cushion material comprising a needle-punched fiber pad, a spunbound fiber pad, a fusion-bonded fiber pad, or a combination thereof.

18. The method of claim 13, wherein stabilizing material is integrated with the stabilizing material by needle-punching, spunbounding, or fusion-bonding.

19. A carpet tile produced by the method of claim 13.

20. A method of manufacturing a carpet tile comprising:
producing a face fabric comprising a plurality of pile extending from a primary carpet base;
producing a dimensionally-stabilized cushion pad comprising a non-woven cushion material and a stabilizing material incorporated therewith;
laminating the dimensionally-stabilized cushion pad to the face fabric with a polymer adhesive; and
curing the polymer adhesive such that it locks the plurality of pile to the primary carpet base and bonds the dimensionally-stabilized cushion pad to the face fabric.
